(19) United States
(12) Patent Application Publication
(10) Pub. No.: US 2019/0190641 A1
(43) Pub. Date: Jun. 20, 2019

(54) Reciprocal Beamforming

(71) Applicant: Google LLC, Mountain View, CA (US)

(72) Inventors: Jibing Wang, Saratoga, CA (US); Erik Richard Stauffer, Sunnyvale, CA (US)

(73) Assignee: Google LLC, Mountain View, CA (US)

(21) Appl. No.: 15/842,318

(22) Filed: Dec. 14, 2017

(51) Int. Cl. H04L 1/00; H01Q 21/28; H04B 7/06; H04W 68/02; H04L 25/06

(52) U.S. Cl. CPC H04L 1/0001; H01Q 21/28; H04W 16/28; H04W 68/02; H04L 25/067; H04B 7/0695

(57) ABSTRACT

The present disclosure describes methods and apparatuses for reciprocal beamforming In some aspects, the techniques include transmitting feedback messages over a same frequency bandwidth of a channel to which the feedback message relates. For example, a user device receives data from a base station on a physical downlink share channel that occupies a bandwidth. The user device attempts to decode data packets of the data and determines which of the data packets were received successfully. The user device prepares an acknowledge/not acknowledge communication to indicate which data packets were successfully received. The acknowledge/not acknowledge communication is transmitted, by the user device, to the base station over an uplink channel The uplink channel occupies communication resources within the bandwidth of the downlink channel

### BACKGROUND

Wireless communication from a user device relies on a wireless connection between the user device and a network node, such as a base station of a wireless network provider. With advances in wireless standards and a demand for increased bandwidth for transmitting and receiving data, wireless network providers are transitioning toward beamforming techniques to increase a quantity of user devices with which the base station can communicate and to increase a range over which the base station can communicate to the user devices.

Beamforming uses an antenna array to increase a signal strength in a desired direction using constructive interference of signal waves produced by the antenna array. Beamforming also decreases a signal strength in other directions using destructive interference of the signal waves. The narrower the beam, the longer a range of the base station and the lower a likelihood of interference from other devices. However, when using a narrow beam, the base station frequently monitors a quality of the wireless connection to determine if adjustments to the beamforming should be made.

### SUMMARY

This document describes techniques for, and systems that enable, reciprocal beamforming For example, the techniques include transmitting feedback messages over a same frequency bandwidth of a channel to which the feedback message relates. These techniques provide opportunities to train a base station for beamforming future transmissions and receptions. In some aspects, a user device receives data from a base station on a downlink channel, such as a physical downlink share channel (PDSCH). The downlink channel occupies a PDSCH bandwidth, which may be assigned by the base station or a mobility management entity of the wireless network. The user device attempts to decode data packets of the data and determines which of the data packets were received successfully. The user device prepares an acknowledge/not acknowledge (ACK/NACK) communication to indicate which data packets were successfully received. The ACK/NACK communication is transmitted, by the user device, to the base station over an uplink channel The uplink channel occupies communication resources within the bandwidth of the downlink channel By the user device transmitting the ACK/NACK communication using resources within the bandwidth of the downlink channel, the base station can use the ACK/NACK communication to learn a beam (through beamforming training) associated with the downlink channel and adjust the beam for transmitting future data.

In other aspects, the user device transmits data to a base station of a wireless connection. The data is transmitted over an uplink channel, such as a physical uplink share channel (PUSCH), which occupies a bandwidth, as assigned by the base station or a mobility management entity of the wireless network. The base station transmits, and the user device receives, a downlink hybrid automatic repeat request (HARQ) message in response to the data transmitted over the uplink channel The downlink HARQ message is received over a downlink channel that occupies communication resources within the bandwidth of the uplink channel By transmitting the downlink HARQ message over resources within the bandwidth of the uplink channel, the base station can learn the uplink channel and adjust the beam to improve future receiving over the uplink channel

The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

The details of one or more aspects of reciprocal beamforming for wireless networks is described below. The use of the same reference numbers in different instances in the description and the figures may indicate like elements:

FIG. 1 illustrates example device configurations of a user device and a base station in accordance with one or more aspects of reciprocal beamforming

FIG. 2 illustrates an example networking environment in which the user device and base station may communicate in accordance with one or more aspects of reciprocal beamforming

FIG. 3 illustrates an example of network communications or operations in accordance with one or more aspects of reciprocal beamforming

FIG. 4 illustrates another example of network communications or operations in accordance with one or more aspects of reciprocal beamforming

FIG. 5 illustrates an example set of resources available to a base station for communication with a user device.

FIG. 6 illustrates another example set of resources available to a base station for communication with a user device.

FIG. 7 illustrates an example method performed by a user device for reciprocal beamforming

FIG. 8 illustrates another example method performed by a user device for reciprocal beamforming

FIG. 9 illustrates another example method performed by a base station for reciprocal beamforming

### DETAILED DESCRIPTION

Beamforming is implemented by base stations of a wireless network and may increase a quantity of available wireless connection for communicating with user devices and increase a range over which a base station can communicate with the user devices. Beamforming can be particularly beneficial for wireless networks operating at high frequencies, as such operation is susceptible to propagation loss due to the high frequencies of the signals. However, training the base station for beamforming communication channels of a wireless connection can be challenging for the base station.

With beamforming, a transceiver coordinates antennas, through phase shifting and weighting of a signal at the antennas, to directionally form a beam. To determine an appropriate direction for the beam, the transceiver performs a process called beamforming training. This training occupies time and consumes resources at one or both of a transmitting device or a receiving device. If the training takes too much time, the beamforming can produce a signal latency that slows communication. Further, while the transmitting device or the receiving device is training the beamforming, the device's processor and RF resources, as well as power resources, are being consumed. This resource consumption can, for example, shorten battery life at a mobile phone or limit how many mobile phones a base station can service at a given time. The beamforming direction can be estimated base on prior signals transmitted or received over the beam. However, with a poor estimation of conditions of the channel, an error rate can increase and a signal quality can decrease. If this happens, the wireless connection may fail and the user device may be unable to communicate with the wireless network.

With conventional wireless connection technology, such as long term evolution (LTE) technology, a user device communicates feedback to a base station using an ACK/NACK or channel quality indicator (CQI) over an uplink channel that is unrelated to the channel to which the feedback relates. In some conventional technologies, the ACK/NCK or CQI are transmitted over a channel that is allocated frequencies at or near an edge of a frequency band.

This document describes techniques and systems for reciprocal beamforming to improve channel learning by a base station of a wireless network. These techniques may include transmitting feedback messages, such as ACK/NCK or CQI messages, over communication resources within a frequency bandwidth of a channel to which the feedback relates. For example, a user device receives application data over a PDSCH. The user device generates an ACK/NACK communication for the base station after analyzing data packets of the application data to determine which of the data packets were successfully received. Instead of transmitting the ACK/NACK communication at unrelated frequencies, the user device transmits the ACK/NACK communication over communication resources within a frequency bandwidth of the PDSCH. By transmitting the ACK/NACK communication over the communication resources within a frequency bandwidth of the PDSCH, the base station can use the ACK/NACK communication to assist in training the beamforming to the user device. This better enables the base station to learn the PDSCH and improve a signal strength and quality of future transmissions while reducing an impact of the training on communication latency or resource utilization. This makes available additional resources for communicating application data such as video streaming or remotely stored files.

The techniques for reciprocal beamforming may include transmitting application data, such as photos for back-up, over a PUSCH. A base station may receive the application data using beamforming receivers of the base station. The PUSCH is allocated a bandwidth including multiple transmission frequencies. When the base station receives the application data, the base station transmits a downlink HARQ message that requests resending of data packets of the application data that were not successfully received. Rather than sending the downlink HARQ message over unrelated frequencies, the base station transmits, and the user device receives, the downlink HARQ message over communication resources within a frequency bandwidth of the PUSCH. By transmitting the downlink HARQ message within the bandwidth of the PUSCH, the base station can learn the uplink channel and adjust the beam to improve receiving future data over the PUSCH.

The following discussion describes an operating environment, an example networking environment in which devices of the operating environment may be implemented, and techniques that may be employed in the operating environment and/or network environment. In the context of the present disclosure, reference is made to the operating environment or networking environment by way of example only.

Operating Environment

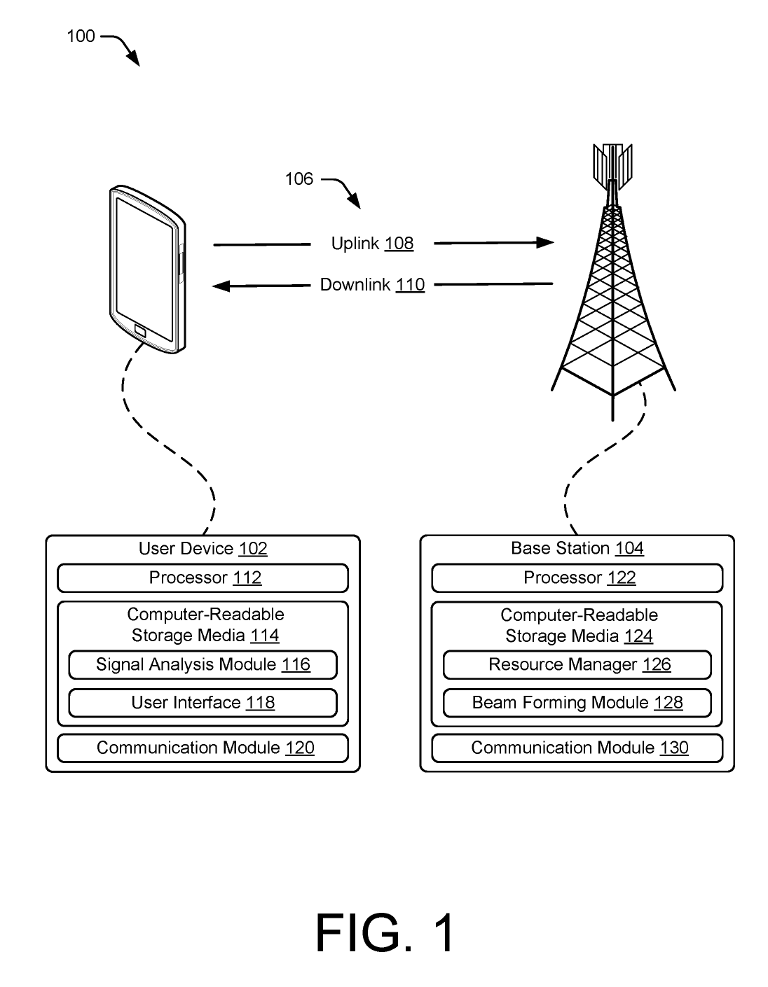

FIG. 1 illustrates an example operating environment 100 in which devices for reciprocal beamforming can be implemented. In this example, the operating environment includes a user device 102 and a base station 104 that are respectively configured to communicate over a wireless connection 106 of a wireless network. Generally, the wireless connection 106 includes an uplink 108 by which the user device 102 transmits data to the base station 104 and a downlink 110 by which the base station 104 transmits other data to the user device 102. Although shown or described with reference to a separate uplink 108 or downlink 110, communication between the user device 102 and base station 104 may also be referenced as a wireless association, a frame exchange, a wireless link, or a communication link.

The wireless connection 106 may be implemented in accordance with any suitable protocol or standard, such as a Global System for Mobile Communications (GSM), Worldwide Interoperability for Microwave Access (WiMax), a High Speed Packet Access (HSPA), Evolved HSPA (HSPA+) protocol, an LTE protocol (e.g., 4G), an LTE Advanced protocol, or a 5′ generation new radio (5G NR) protocol. The wireless connection 106 may operate over a high bandwidth, such as a bandwidth greater than 1 GHz. Further, the wireless connection 106 may operate at high frequencies, such as frequencies above 3 GHz. More specifically, the wireless connection 106 may operate at frequencies above 3.5 GHz, 5 GHz, 10 GHz, or 20 GHz. When operating at high-frequencies, beam forming may be particularly important, based on propagation loss, to provide an adequate range and signal strength of the wireless connection 106.

The user device 102 includes a processor 112, computer-readable storage media 114 having a signal analysis module 116 and a user interface 118, and a communication module 120. The user device 102 is illustrated as a smart phone, however the user device may instead be implemented as any device with wireless communication capabilities, such as a mobile gaming console, a tablet, a laptop, an advanced driver assistance system (ADAS), a point-of-sale (POS) terminal, a health monitoring device, a drone, a camera, a media-streaming dongle, a wearable smart-device, an internet-of-things (IoT) device, a personal media device, a navigation device, a mobile-internet device (MID), a wireless hotspot, a femtocell, or a broadband router.

The processor 112 of the user device 102 can execute processor-executable instructions or code stored by the computer-readable storage media (CRM) 114 to cause the user device 102 to perform operations or implement various device functionalities. In some cases, the processor 112 is implemented as an application processor (e.g., multicore processor) or a system-on-chip with other components of the user device integrated therein. The CRM 114 may include any suitable type of memory media or storage media, such as read-only memory (ROM), programmable ROM (PROM), random access memory (RAM), static RAM (SRAM), or Flash memory. In the context of this discussion, the CRM 114 of the user device 102 is implemented as hardware-based storage media, which does not include transitory signals or carrier waves. In some cases, the CRM 114 stores one or more of firmware, an operating system, or applications of the user device 102 as instructions, code, or information. The instructions or code can be executed by the processor 112 to implement various functionalities of the user device 102, such as those related to network access or audio encoding features. In this example, the CRM 114 also stores processor-executable code or instructions for implementing one or more of the signal analysis module 116 or the user interface 118 the user device 102.

In some aspects, the signal analysis module 116 may analyze data packets of data received over the wireless connection 106. The signal analysis module 116 determines which of the data packets were successfully received and which of the data packets were not successfully received. Based on the analysis of the signal analysis module 116, the user device 102 generates feedback, including one or more of an ACK/NACK or channel quality indicator (CQI) communication, for transmitting to the base station 104. The feedback is transmitted to the base station 104 over resources of the wireless connection 106 that are related to a channel of the downlink 110 over which the data is received.

For example, the feedback is transmitted over resources that are interleaved across a frequency bandwidth of the channel of the downlink 110 over which the data is received. Alternatively, the feedback is transmitted over a subset of the frequency bandwidth for an interval of time. After the interval of time, the subset hops throughout the frequency bandwidth of the channel of the downlink 110. Additionally or alternatively, the channel of the uplink 108 or the downlink 110 may be multilayered. When the channel of the uplink 108 or the downlink 110 is multilayered, feedback corresponding to data of the uplink 108 or the downlink 110 may be transmitted over multiple layers corresponding to the multiple layers of the channel For example, multiple ACK/NACK communications may be transmitted over the multiple layers of the channel The ACK/NACK communications are transmitted on layers corresponding to the data of the uplink 108 or the downlink 110 to which they provide feedback. This may assist the base station 102 with learning the multiple layers of the channel of the uplink 108 or the downlink 110 through beamforming training. In some implementations, the feedback may be transmitted over a channel of the uplink 108 having a same quantity of layers as the channel of the downlink 110, or visa versa.

The communication module 120 of the user device 102 includes a hardware-based transceiver and associated circuitry or other components for communicating with the base station 104 via a wireless medium. For example, the communication module 120 may transmit, via a transmitter of the transceiver, data to the base station 104 via one or more channels of the uplink 108. This data transmitted to the base station 104 may include any suitable type of framed or packetized information, such as a device location, and ACK/NACK communication, a CQI communication, a sounding reference signal (SRS), a PRACH communication, device status information, wireless connection status information, wireless connection control information, data requests, data, or network access requests. The communication module 120 may also receive, via a receiver of the transceiver, other data from the base station 104, such as a CSI reference signal, wireless connection configuration settings, network control information, or a communication mode selection.

In this example, the base station 104 is shown generally as a cellular base station of a wireless network. The base station 104 may be implemented to manage a cell of a wireless network that includes multiple other base stations that each manage another respective cell of the wireless network. As such, the base station 104 may communicate with a network management entity or others of the multiple base stations to coordinate connectivity or hand-offs of mobile stations within or across the cells of the wireless network. The base station 104 can be configured as any suitable type of base station or network management node, such as a Global System for Mobile Communications (GSM) base station, a node base (Node B) transceiver station (e.g., for UMTS), an evolved NodeB (eNB, e.g., for LTE), or a next generation Node B (gNB, e.g., for 5G NR). As such, the base station 104 may control or configure parameters of the uplink 108 or the downlink 110 in accordance with one or more of the wireless standards or protocols described herein.

The base station 104 includes a processor 122, a computer-readable storage media (CRM) 124 having a resource manager 126 and a beamforming module 128, and a communication module 130. The processor 122 can execute processor-executable instructions or code stored by the CRM 124 to perform operations or implement various base station functionalities. In some cases, the processor 122 is implemented as multiple processor cores or a multicore processor configured to execute firmware or an operating system of the base station 104. The CRM 124 may include any suitable type of memory media or storage media, such as ROM, PROM, RAM, SRAM, or Flash memory. In the context of this discussion, the CRM 124 is implemented as hardware-based storage media, which does not include transitory signals or carrier waves. The CRM 124 of the base station 104 may store firmware, an operating system, or applications of the base station as instructions, code, or other information. The instructions or code can be executed by the processor 122 to implement various functionalities of the base station 104, such as to manage connectivity or parameters of the wireless connection 106 with the user device 102. In this example, the CRM 124 also stores processor-executable code or instructions for implementing the resource manager 126 and the beamforming module 128 of the base station 104.

In some aspects, the resource manager 126 of the base station 104 is implemented to perform various functions associated with allocating physical access (e.g., resource blocks) or communication resources available to the base station 104. The physical access, such as an air interface of the base station 104, may be partitioned or divided into various units (e.g., frames) of one or more of bandwidth, time, symbols, or layers. For example, within a framework of the LTE protocol, the resource manager 126 can allocate bandwidth and time intervals of access in resource blocks, each of which can include multiple layers and may be allocated in whole, or in part, to one or more channels for communicating with the user device 102.

The resource manager 126 may assign a channel of the uplink 108, over physical accesses, to communication resources within a frequency bandwidth of the wireless connection 106. The resource manager 126 may also assign a channel of the downlink 110 to communication resources within the same frequency bandwidth of the wireless connection 106. In some implementations, the channel of the downlink 110 is configured for receiving feedback relating to data communicated over the channel of the uplink 108.

Additionally or alternatively, the resource manager 126 may assign a channel of the downlink 110 to communication resources within a frequency bandwidth of the wireless connection 106. The resource manager 126 may also assign a channel of the uplink 108 to communication resources within the same frequency bandwidth of the wireless connection 106. In some implementations, the channel of the uplink 108 is configured for transmitting feedback relating to data communicated over the channel of the downlink 110.

The identification of the assigned resources may include one or both of frequencies or time locations of the assigned resource elements. The one or both of the frequencies or the time locations may be effective to enable the user device 102 to communicate via the selected resource elements. In such an instance, the indication may be communicated from the base station 104 to the user device 102 as part of a Radio Resource Control (RRC) message or Downlink Control Information (DCI) message. The assignment may be static, or may include a hopping pattern for changing the resources allocated to various channels of the wireless connection 106 over intervals of time.

The beamforming module 128 receives the assignment of resources from the resource manager 126 and beamforms an identification of the assigned resources to the user device 102 via the downlink 110. To beamform, the beamforming module 128 coordinates an antenna array of the communication module 130 to transmit the signal in a direction toward the user device 102. To transmit in a desired direction, the beamforming module 128 causes a phase change of the signal transmitted via the antennas of the antenna array such that constructive interference occurs in the desired direction. The beamforming module 128 may also modify weights of signals produced by the antennas of the antenna array to improve one or more of a quality or a range of the signal.

The communication module 130 of the base station 104 includes a receiver, a transmitter, and associated circuitry or other components for communicating with the user device 102 via the wireless medium. In some cases, the communication module 130 includes, or is coupled with, multiple hardware-based transceivers and antenna arrays that are configured to establish and manage wireless connections with multiple user devices. The base station 104 may communicate any suitable data or information to the user device 102 through the downlink 110, such as a schedule of allocated resources, downlink HARQ messages, application data, wireless connection status information, or wireless connection control information.

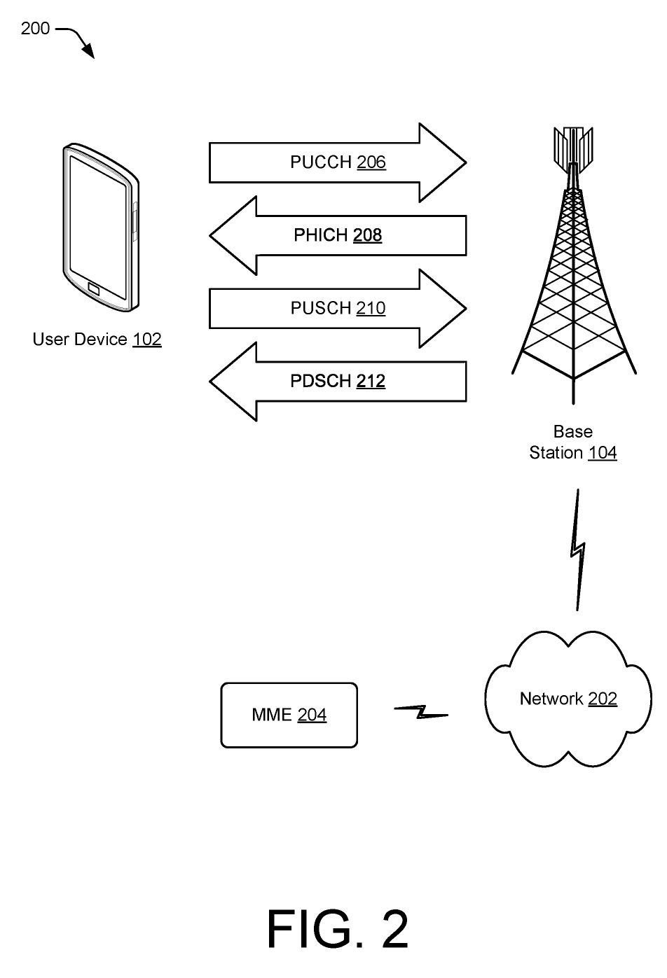

FIG. 2 illustrates an example networking environment 200 in which a user device and a base station may communicate in accordance with one or more aspects. The network environment includes respective instances of the user device 102 and the base station 104, which provides a wireless network with which the user device 102 and other mobile stations may associate. Through the wireless network, the base station 104 may enable or provide access to other networks or resources, such as a network 202 (e.g., the Internet) connected via a backhaul link (e.g., fiber network). Alternately or additionally, the networking environment 200 may include other base stations or a mobility management entity (MME) 204 to provide an area wide wireless network, such as a 5G NR network and associated data services.

The user device 102 and/or the base station 104 may communicate through any suitable type or combination of channels, message exchanges, or network management procedures. In this example, the user device 102 and the base station 104 communicate via one or more of a physical uplink control channel (PUCCH) 206, a physical HARQ indicator channel (PHICH) 208, a PUSCH 210, or a PDSCH 212. The PUCCH 206 may be useful to transmit, to the base station 104, one or more of an ACK/NACK communication, a channel quality indicator (CQI) communication, multiple-input-multiple-output (MIMO) feedback such as a rank indicator (RI) or a precoding matrix indicator (PMI), scheduling requests for uplink transmission, or binary phase-shift keying (BPSK) or quadrature phase-shift keying (QPSK) for PUCCH modulation.

The PHICH 208 can be used to communicate downlink HARQ messages, such as ACK/NACK communications, for data received from the user device 102 via the PUSCH 210. For example, after receiving data from the user device, the base station 104 communicates feedback, including ACK/NACK communications to indicate to the user device 102 which data packets were received successfully. Based on the ACK/NACK communication, the user device 102 may resend unsuccessful data packets via the PUSCH 210.

The user device 102 may send additional data to the base station 104 via the PUSCH 210. The PUSCH 210 may include one or more of RRC communications, uplink control information (UCI) messages, or application data. The PUSCH 210 is typically the channel on which application data is transmitted from the user device 102 to the base station 104. Alternately or additionally, the user device may send ACK/NACK communications via the PUSCH.

The base station 104 may send additional data to the user device 102 via the PDSCH. The PDSCH may include application data, downlink control information (DCI) and/or a Radio Resource Control (RRC) to the user device 102. Additionally or alternatively, the PDSCH 212 may be used to send HARQ messages to the user device 102. The DCI may include identification of resource elements to be used for communication of data between the user device 102 and the base station 104. In some implementations, the DCI may instruct the user device 102 to follow a hopping pattern for using resource elements for communication with the base station 104. The DCI may also include a modulation scheme and coding/decoding information for the user device 102 to access the data communicated to the user device 102.

In some aspects of reciprocal beamforming, two or more of the PUCCH 206, the PHICH 208, the PUSCH 210, or the PDSCH 212 are assigned to resources within a same frequency bandwidth. For example, the PUCCH 206 may be assigned to resources interleaved with resources assigned to the PDSCH 212. Additionally or alternatively, the PHICH 208 may be assigned to resources that hop across a frequency bandwidth of resources assigned to the PUSCH. Furthermore, two or more of the PUCCH 206, the PHICH 208, the PUSCH 210, or the PDSCH 212 may include a same quantity of layers.

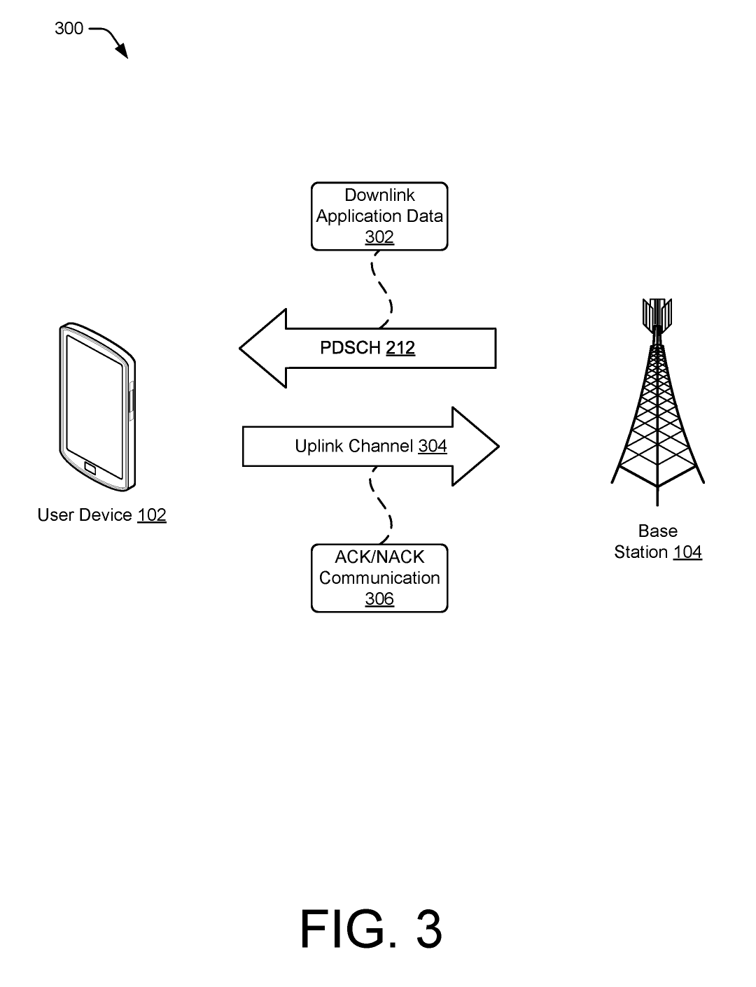

FIG. 3 illustrates an example of network communication or operations at 300 in accordance with one or more aspects of reciprocal beamforming The networking environment 300 includes respective instances of the user device 102 and the base station 104 that provides the wireless connection 106. In this example, the base station 104 transmits downlink application data 302 via the PDSCH 212. The user device 102 replies, via an uplink channel 304, with an ACK/NACK communication. The uplink channel 304 may include the PUCCH 206 or the PUSCH 210, as described in FIG. 2.

The user device 102, for example, may have requested, from the user device 102, the downlink application data 302, such as a webpage for viewing on the user device 102. When the user device 102 receives data packets of the downlink application data 302 over the PDSCH 212, the user device 102 will check to ensure that it received each of the data packets successfully. The user device 102 will prepare the ACK/NACK communication 306 for the base station 104 so the base station 104 can determine which data packets of the downlink application data 302 to resend. However, rather than sending the ACK/NACK communication 306 over frequencies that are unrelated to a frequency bandwidth over which the downlink application data 302 was sent, the uplink channel 304 is assigned to communication resources within the frequency bandwidth of the PDSCH 212. In this way, not only is the base station 104 receiving a report of data packets that were successfully and unsuccessfully received, it receives a transmission from the user device to assist in learning the PDSCH 212. As the base station 104 learns the PDSCH 212, a signal quality of transmissions over the PDSCH 212 may increase and a quantity of unsuccessfully received data packets may decrease.

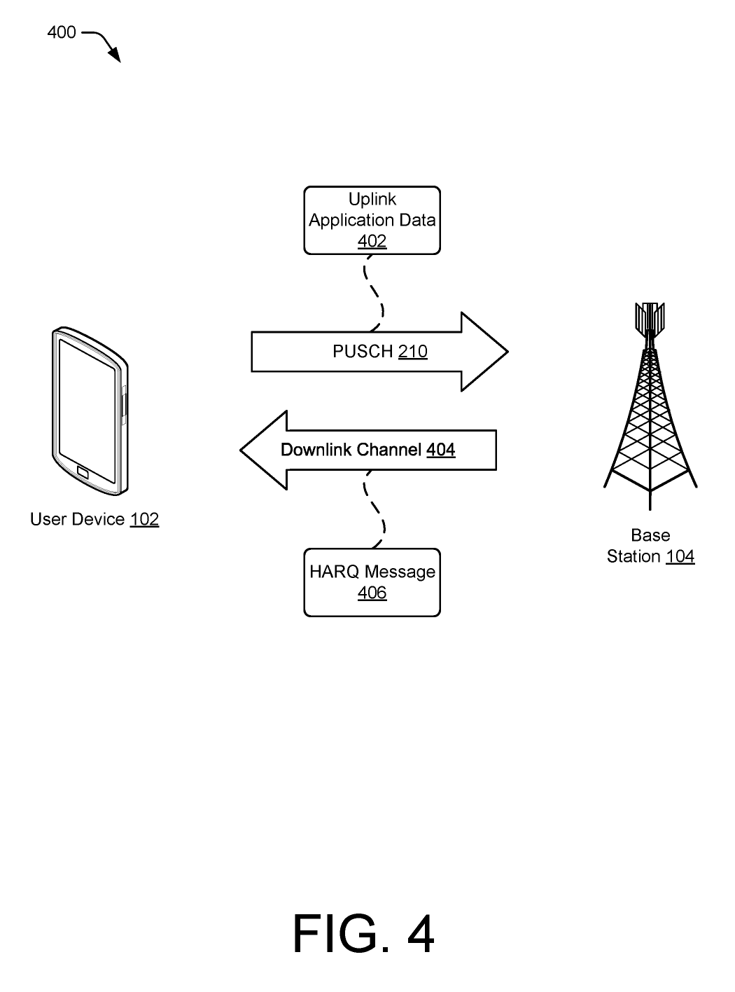

FIG. 4 illustrates an example of network communication or operations at 400 in accordance with one or more other aspects of reciprocal beamforming The networking environment 400 includes respective instances of the user device 102 and the base station 104 that provides the wireless connection 106. In this example, the user device 102 transmits uplink application data 402 via the PUSCH 210. The base station 104 replies, via a downlink channel 404, with a HARQ message 406. The downlink channel 404 may include the PHICH 210 or the PDSCH 212, as described in FIG. 2. Alternatively, the downlink channel 404 may include a physical downlink control channel (PDCCH), a physical control format indicator channel (PCFICH) or a physical broadcast channel (PBCH), so long as the downlink channel 404 is configured to carry the HARQ message 406 or another downlink ACK/NACK communication.

The user device 102, for example, may have transmitted the uplink application data 402, such as a video, to the base station 104 for online storage. When the base station 104 receives data packets of the uplink application data 402 over the PUSCH 210, the base station 104 analyzes the data packets to ensure that it received each of the data packets successfully. The base station 104 prepares the HARQ message 406 for the user device 102 so the user device 102 can determine which data packets of the uplink application data 402 to resend. However, rather than sending the HARQ message 406 over frequencies that are unrelated to a frequency bandwidth over which the uplink application data 402 was sent, the downlink channel 404 is assigned to communication resources within the frequency bandwidth of the PUSCH 210. In this way, the user device 102 receives a report of data packets that were successfully and unsuccessfully received, and the base station can use the transmissions of one or more of the uplink application data 402 or the HARQ message 406 to learn the PUSCH 210 or the downlink channel 404. As the base station 104 learns the PUSCH 210, beamforming for receiving transmissions over the PUSCH 210 may improve and therefore, a quantity of unsuccessfully received data packets may decrease.

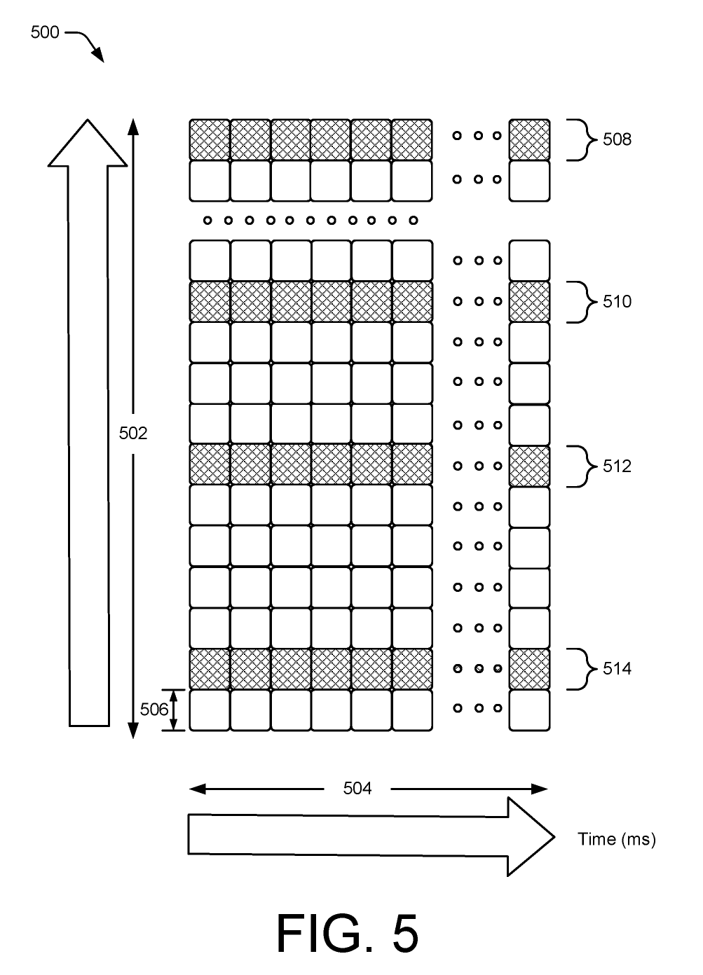

FIG. 5 illustrates an example set 500 of resources available to the base station 104 for communication with the user device 102 over the wireless network. The set 500 of resources spans a frequency bandwidth 502 and a time range 504. Resources of the set 500, as defined by a communication protocol or standard, span a specified frequency range 506. Each resource of subsets 508, 510, 512, and 514 of common-frequency resources spans a portion of the frequency bandwidth 502. The resources, shown as boxes, may be resource blocks, resource elements, orthogonal frequency-division multiplexing (OFDM) symbols, or single-carrier frequency-division multiplexing (SC-FDM) symbols. In some implementations, resources for feedback are interleaved across all, or substantially all, of the frequency bandwidth 502 of a channel to which the feedback relates. For example, the subsets 508, 510, 512, and 514 are interleaved across substantially all of the frequency bandwidth 502.

In some aspects of reciprocal beamforming, the set 500 of resources may include resource blocks over the frequency bandwidth 502 of a PUSCH, such as the PUSCH 210. Resources occupied by, or assigned to, a downlink channel are interleaved with resources assigned to the PUSCH within the frequency bandwidth 502. The downlink channel may include a PHICH, such as the PHICH 208, or a PDSCH, such as the PDSCH 212, so long as the channel is configured to carry feedback for data received over the PUSCH.

In other aspects of reciprocal beamforming, the set 500 of resources may include resource blocks over the frequency bandwidth 502 of a PDSCH, such as the PDSCH 212. Resources occupied by, or assigned to, an uplink channel are interleaved with resources assigned to the PDSCH within the frequency bandwidth 502. The uplink channel may include a PUCCH, such as the PUCCH 206, or a PUSCH, such as the PUSCH 210, so long as the channel is configured to carry feedback for data received over the PDSCH.

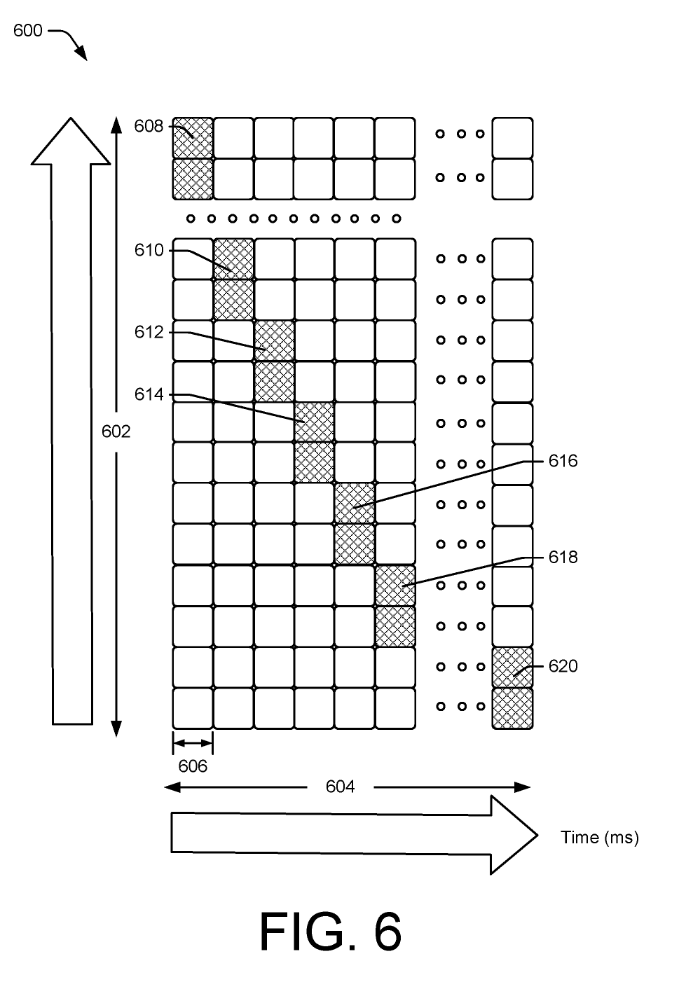

FIG. 6 illustrates an example set 600 of resources available to the base station 104 for communication with the user device 102 over the wireless network. The set 600 of resources spans a frequency bandwidth 602 and a time range 604. Resources of the set 600, as defined by a communication protocol or standard, span a specified time interval 606. The resources, shown as boxes, may be resource blocks, resource elements, OFDM symbols, or SC-FDM symbols. In some implementations, resources for feedback follow a hopping pattern across all, or substantially all, of the frequency bandwidth 602 of a channel to which the feedback relates. For example, the subsets 608, 610, 612, 614, 616, 618, and 620 hop across substantially all of the frequency bandwidth 602 over the time range 604.

In some aspects of reciprocal beamforming, the set 600 of resources may include resource blocks over the frequency bandwidth 602 of a PUSCH, such as the PUSCH 210. Resources occupied by, or assigned to, a downlink channel hop across the frequency bandwidth 602 over successive time intervals. The downlink channel may include a PHICH, such as the PHICH 208, or a PDSCH, such as the PDSCH 212, so long as the channel is configured to carry feedback for data received over the PUSCH. The resources occupied by the downlink channel may hop after one or more OFDM symbols, SC-FDM symbols, or resource blocks. The resources occupied by the downlink channel may hop across all of the frequency bandwidth 602, or may hop across a portion of the frequency bandwidth 602. In another time range, the resources occupied by the downlink channel may hop across the frequency bandwidth 602 in a different pattern and may hop across a different portion of the frequency bandwidth 602.

In other aspects of reciprocal beamforming, the set 600 of resources may include resource blocks over the frequency bandwidth 602 of a PDSCH, such as the PDSCH 212. Resources occupied by, or assigned to, an uplink channel hop across the frequency bandwidth 602 over successive time intervals. The uplink channel may include a PUCCH, such as the PUCCH 206, or a PUSCH, such as the PUSCH 210, so long as the channel is configured to carry feedback for data received over the PDSCH. The resources occupied by the uplink channel may hop after one or more OFDM symbols, SC-FDM symbols, or resource blocks. The resources occupied by the uplink channel may hop across all of the frequency bandwidth 602, or may hop across a portion of the frequency bandwidth 602. In another time range, the resources occupied by the uplink channel may hop across the frequency bandwidth 602 in a different pattern and may hop across a different portion of the frequency bandwidth 602.

Techniques for Reciprocal Beamforming

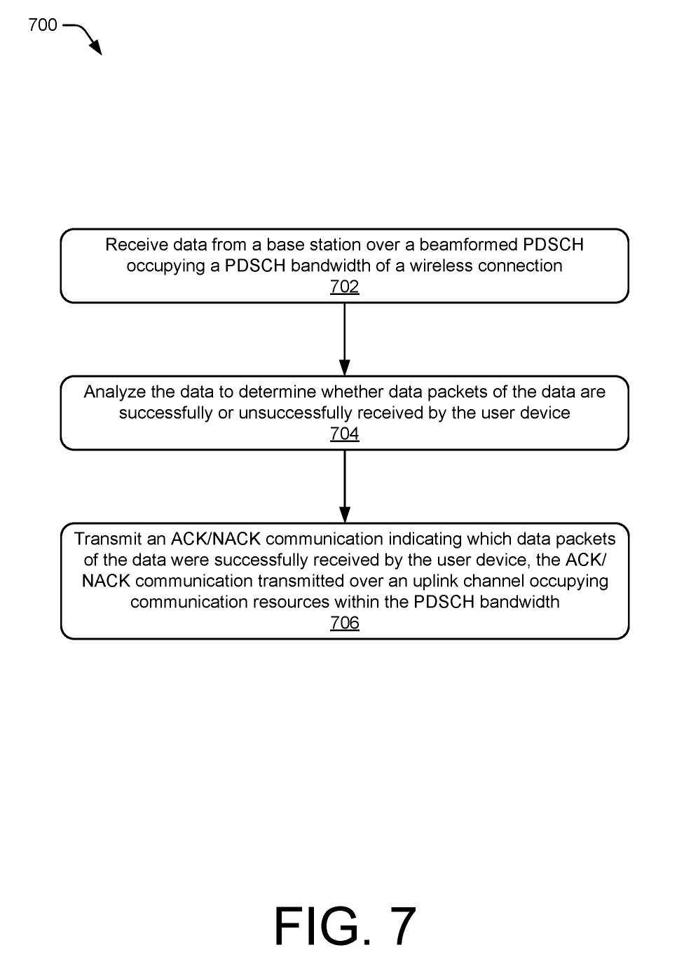

FIGS. 7-9 depict methods for implementing reciprocal beamforming in wireless networks. These methods are shown as sets of blocks that specify operations performed but are not necessarily limited to the order or combinations shown for performing the operations by the respective blocks. For example, operations of different methods may be combined, in any order, to implement alternate methods without departing from the concepts described herein. In portions of the following discussion, the techniques may be described in reference to FIGS. 1-6, reference to which is made for example only. The techniques are not limited to performance by one entity or multiple entities operating on one device, or those described in these figures.

FIG. 7 illustrates an example method 700 for reciprocal beamforming, including operations performed by a signal analysis module, such as the signal analysis module 116, and a communication module, such as the communication module 120. In some aspects, operations of the method 700 may be implemented to improve beam learning by a base station, such as the base station 104.

At operation 702, a user device receives data from a base station. The user device receives the data over a beamformed PDSCH occupying a PDSCH bandwidth of a wireless connection. For example, the user device 102 receives, via the communication module 120, the downlink application data 302 over the PDSCH 212. The PDSCH occupies a PDSCH bandwidth that includes, for example, the frequency bandwidth 502 or the frequency bandwidth 602.

At operation 704, the user device analyzes the data to determine whether data packets of the data are successfully or unsuccessfully received by the user device. For example, the signal analysis module 116 analyzes data packets of the downlink application data 302 to determine which of the data packets were successfully received.

At operation 706, the user device transmits an ACK/NACK communication indicating which data packets of the data were successfully received by the user device. The ACK/NACK communication is transmitted over an uplink channel occupying communication resources within the PDSCH bandwidth of the wireless connection. The ACK/NACK communication is usable by the base station to improve a quality of the beamformed PDSCH. For example, the user device 102 transmits, via the communication module 120, the ACK/NACK communication 306 over the uplink channel 304. The uplink channel may include the PUCCH 206 or the PUSCH 210, so long as the uplink channel is configured to carry the ACK/NACK communication 306. The uplink channel may occupy communication resources within the PDSCH bandwidth of the wireless connection by interleaving the uplink channel resources as illustrated in FIG. 5. Alternatively, the uplink channel may occupy communication resources within the PDSCH bandwidth of the wireless connection by hopping across a frequency bandwidth of the PDSCH resources as illustrated in FIG. 6.

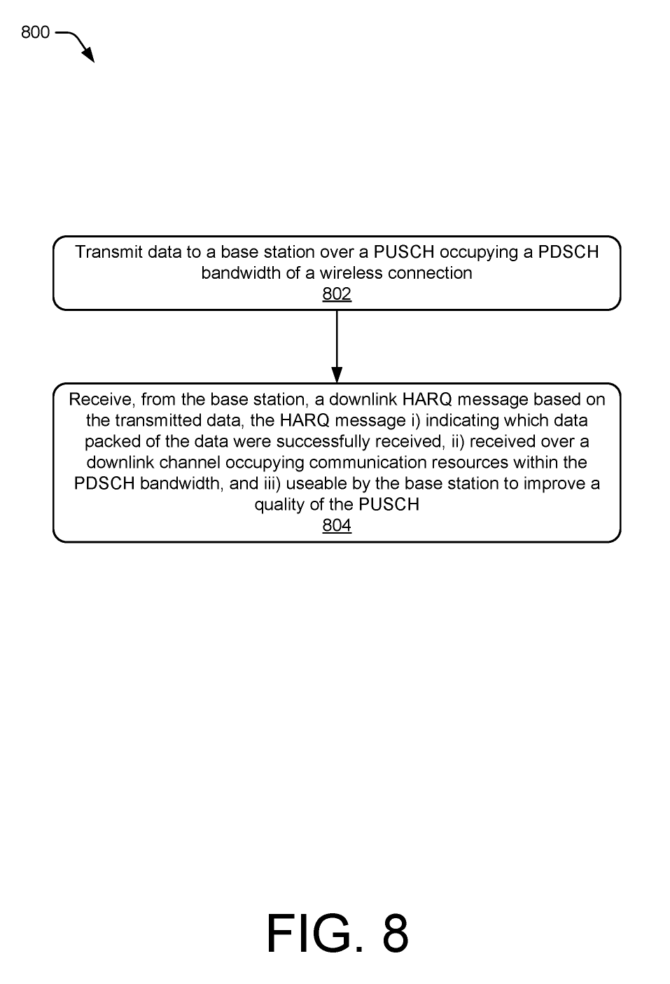

FIG. 8 illustrates an example method 800 for reciprocal beamforming, including operations performed by a signal analysis module, such as the signal analysis module 116, and a communication module, such as the communication module 120. In some aspects, operations of the method 800 may be implemented to improve beam learning by a base station, such as the base station 104.

At operation 802 a user device transmits data to a base station over a PUSCH occupying a PUSCH bandwidth of a wireless connection. The user device 102 may transmit the data using a hardware-based transceiver. For example, the user device 102 transmits, via the communication module 120, the uplink application data 402 to the base station 104 over the PUSCH 210. The PUSCH may include, for example, the frequency bandwidth 502 or the frequency bandwidth 602.

At operation 804, the user device receives, from the base station, a downlink HARQ message. The HARQ message indicates which data packets of the data were received successfully by the base station. The user device receives the HARQ message over a downlink channel occupying communication resources within the PUSCH bandwidth of the wireless connection. The HARQ message is also usable by the base station to improve a quality of the PUSCH. For example, the user device 102 receives the HARQ message 406 from the base station 104 over the downlink channel 404. The HARQ message 406 indicates to the user device 102 which data packets of the uplink application data 402 were received successfully by the base station 104. By sending the HARQ message 406 over communication resources within the PUSCH bandwidth of the wireless connection, the base station 104 is able to tune a PUSCH beam.

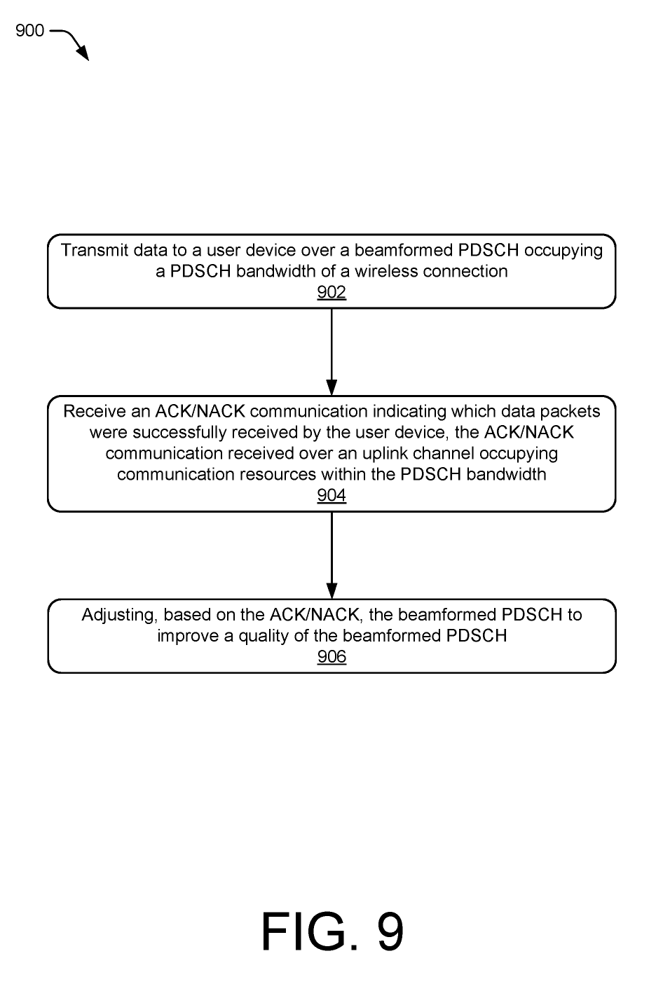

FIG. 9 illustrates an example method 900 for reciprocal beamforming, including operations performed by a base station, such as the base station 104. In some aspects, operations of the method 900 may be implemented to improve beamforming a PDSCH.

At operation 902, a base station transmits data to a user device. The base station transmits the data over a beamformed PDSCH occupying a PDSCH bandwidth of a wireless connection. For example, the base station 104 transmits, via the communication module 130, the downlink application data 302 over the PDSCH 212. The PDSCH occupies a PDSCH bandwidth that includes, for example, the frequency bandwidth 502 or the frequency bandwidth 602.

At operation 904, the base station receives an ACK/NACK communication indicating which data packets were successfully received by the user device. The ACK/NACK communication is received over an uplink channel occupying communication resources within the PDSCH bandwidth of the wireless connection. For example, the signal analysis module 116 analyzes data packets of the downlink application data 302 to determine which of the data packets were successfully received. For example, the base station 104 receives, via the communication module 130, the ACK/NACK communication 306 over the uplink channel 304. The uplink channel may include the PUCCH 206 or the PUSCH 210, so long as the uplink channel is configured to carry the ACK/NACK communication 306. The uplink channel may occupy communication resources within the PDSCH bandwidth of the wireless connection by interleaving the uplink channel resources as illustrated in FIG. 5. Alternatively, the uplink channel may occupy communication resources within the PDSCH bandwidth of the wireless connection by hopping across a frequency bandwidth of the PDSCH resources as illustrated in FIG. 6.

At operation 906, the base station adjusts, based on the ACK/NACK, the beamformed PDSCH to improve a quality of the beamformed PDSCH. For example the base station may adjust weights of various arrays of an antenna array to improve the quality of the beamformed PDSCH.

Although techniques using, and apparatuses for implementing, reciprocal beamforming have been described in language specific to features and/or methods, it is to be understood that the subject of the appended claims is not necessarily limited to the specific features or methods described. Rather, the specific features and methods are disclosed as example ways in which reciprocal beamforming can be implemented.

1. A method of reciprocal beamforming performed by a user device, the method comprising:
receiving, via a transceiver of the user device and over a wireless connection, data from a base station, the data received over a beamformed physical downlink share channel (PDSCH) occupying a PDSCH bandwidth of the wireless connection;
analyzing the data to determine whether data packets of the data are successfully or unsuccessfully received by the user device; and
transmitting, to the base station via the transceiver of the user device, an acknowledge/not acknowledge (ACK/NACK) communication indicating which data packets of the data were successfully received by the user device, the ACK/NACK communication:
transmitted over an uplink channel occupying communication resources within the PDSCH bandwidth of the wireless connection; and
usable by the base station for beamforming training to improve the beamformed PDSCH.

2. The method as recited in claim 1, wherein the uplink channel comprises a physical uplink control channel (PUCCH).

3. The method as recited in claim 1, wherein the uplink channel comprises a physical uplink share channel (PUSCH).

4. The method as recited in claim 1, wherein the uplink channel has a same quantity of layers as the beamformed PDSCH.

5. The method as recited in claim 4, wherein the communication resources occupied by the uplink channel include communication resources that are interleaved with PDSCH communication resources.

6. The method as recited in claim 4, wherein the communication resources occupied by the uplink channel include a subset of the PDSCH bandwidth that hops across the PDSCH bandwidth over successive time intervals.

7. The method as recited in claim 6, wherein the successive time intervals include successive orthogonal frequency-division multiplexing symbols or successive single-carrier frequency-division multiplexing symbols.

8. The method as recited in claim 1, wherein:
the beamformed PDSCH includes multiple downlink layers on a same frequency resource; and
the transmitting comprises:
transmitting additional ACK/NACK communications for the multiple downlink layers; and
transmitting the additional ACK/NACK communications on the same frequency resource and on the multiple downlink layers.

9. The method as recited in claim 1, wherein the PDSCH bandwidth of the wireless connection includes frequencies above 3 GHz.

10. The method as recited in claim 4, wherein the wireless connection uses a 5th generation new radio (5G NR) protocol.

11. A user device comprising:
a processor;
a hardware-based transceiver: and
a computer-readable storage medium having stored thereon instructions that, responsive to execution by the processor, cause the processor to perform operations comprising:
transmitting, via the hardware-based transceiver and over a wireless connection, data to a base station, the data transmitted over a physical uplink share channel (PUSCH) occupying a PUSCH bandwidth of the wireless connection; and
receiving, from the base station and via the hardware-based transceiver, a downlink hybrid automatic repeat request (HARQ) message based on the data, the HARQ message:
indicating which data packets of the data were received successfully by the base station; and
received over a downlink channel occupying communication resources within the PUSCH bandwidth of the wireless connection;
usable by the base station for beamforming training.

12. The user device as recited in claim 11, wherein the downlink channel is one of a physical HARQ indicator channel or a physical downlink share channel (PDSCH).

13. The user device as recited in claim 12, wherein the downlink channel is a PDSCH having a same quantity of layers as the PUSCH.

14. The user device as recited in claim 11, wherein the communication resources occupied by the downlink channel include communication resources that are interleaved with PUSCH communication resources.

15. The user device as recited in claim 11, wherein the communication resources occupied by the downlink channel include a subset of the PUSCH bandwidth that hops across the PUSCH bandwidth over successive time intervals.

16. The user device as recited in claim 15, wherein the successive time intervals include successive orthogonal frequency-division multiplexing symbols or successive single-carrier frequency-division multiplexing symbols.

17. A method of reciprocal beamforming performed by a base station of a wireless network, the method comprising:
transmitting, via a transceiver of the base station and over a wireless connection, data to a user device, the data transmitted over a beamformed physical downlink share channel (PDSCH) occupying a PDSCH bandwidth of the wireless connection;
receiving, via the transceiver of the base station, an acknowledge/not acknowledge (ACK/NACK) communication indicating which data packets were successfully received by the user device, the ACK/NACK communication received over an uplink channel occupying communication resources within the PDSCH bandwidth of the wireless connection; and
adjusting, based on the ACK/NACK communication, the beamformed PDSCH to improve a quality of the beamformed PDSCH.

18. The method as recited in claim 17, wherein adjusting the beamformed PDSCH includes modifying weights of antennas of an antenna array used by the base station for beamforming the PDSCH.

19. (canceled)

20. The method as recited in claim 17, wherein the uplink channel includes a same quantity of layers as the PDSCH.

21. The method as recited in claim 20, wherein the wireless connection uses a 5th generation new radio (5G NR) protocol.
